(19) United States
(12) Patent Application Publication
(10) Pub. No.: US 2025/0129822 A1
(43) Pub. Date: Apr. 24, 2025

(54) DISENGAGEABLE GEARBOX FOR ELECTRIC PALLET TRUCK

(71) Applicant: ZHEJIANG MICROLIFT INTELLIGENT EQUIPMENT CO., LTD., HANZHOU (CN)

(72) Inventors: DIGUO YUE, JIAXING (CN); WEN TANG, JIAXING (CN)

(21) Appl. No.: 19/001,503

(22) Filed: Dec. 25, 2024

Related U.S. Application Data
(63) Continuation of application No. PCT/CN2023/085898, filed on Apr. 3, 2023.

(30) Foreign Application Priority Data
Mar. 28, 2023 (CN) 202310316625.8

(51) Int. Cl. F16D 11/10; F16D 23/14; F16H 1/20

(52) U.S. Cl. CPC F16D 11/10; F16D 23/14; F16H 1/20; F16D 2023/141

(57) ABSTRACT

Disclosed is a disengageable gearbox for an electric pallet truck, including a box body and a box cover assembled with the box body. The box body and the box cover are assembled to form a mounting chamber. A gear set is mounted in the box body. A disengagement mechanism is provided in the gear set. The disengagement mechanism achieves engagement or disengagement of the gear set, so that the gear set transmits or terminates torque output. The disengagement mechanism includes a key sleeve. An inner key is engaged with a key shaft. An outer key is engaged with a keyway in a transmitting gear. The key sleeve is movable on the key shaft along an axial direction. When the outer key of the key sleeve is disengaged from the keyway in the transmitting gear, torque is not transmitted between the transmission gear and the key sleeve.

### TECHNICAL FIELD

The present disclosure belongs to the technical field of gearboxes, and in particular to a disengageable gearbox for an electric pallet truck.

### BACKGROUND

A pallet truck is a logistics apparatus that plays a role in transporting goods. Pallet trucks are divided into two kinds, i.e., manual pallet trucks and electric pallet trucks. Pallet trucks mainly have two functions, i.e., lifting and walking. The lifting function is achieved through a hydraulic system, either manually or electrically. The walking function is achieved by rolling wheels, which may be manually pushed and pulled by an operator or driven by a motor. In the case of motor driving, a reduction gearbox is used. The reduction gearbox is composed of gear transmission, worm transmission, and gear-worm transmission enclosed in a rigid housing. It is commonly used as a reduction transmission device between a driving link and a working machine.

For example, in an electric forklift motor with application number 201921338575.9, its gear assembly includes a gearbox cover and six gears. The first gear is engaged with a second gear. The second gear is engaged with a third gear. The third gear is engaged with a fourth gear. The fourth gear is fitted onto a transmission shaft. And the transmission shaft is fitted with a fifth gear. The fifth gear is engaged with a sixth gear. The sixth gear is fitted onto a tire output shaft.

In the above technical solution, when the motor shaft cannot be used normally, the gear assembly cannot operate normally, and the pallet truck will stop moving. It is difficult to manually push the pallet truck to make it move, because the gears in the gearbox are engaged with each other, the force of tire rotation can hardly drive the gears to rotate in a reverse direction, and the motor shaft does not rotate. This will cause the pallet truck to stop in the middle of the road, posing a safety hazard.

### SUMMARY

In view of the disadvantages in the background, a purpose of the present disclosure is to provide a disengageable gearbox for an electric pallet truck. It can achieve disengagement of gears when the gearbox is not required for transmission, so that the electric pallet truck can be manually pushed or pulled by an operator.

In order to solve the above technical problem, the purpose of the present disclosure is achieved by adopting the following technical solution:

A disengageable gearbox for an electric pallet truck includes:
a box body and a box cover assembled with the box body, where the box body and the box cover are assembled to form a mounting chamber;
a gear set is mounted in the box body and a disengagement mechanism is provided in the gear set;
the disengagement mechanism enables engagement or disengagement of gear sets, to transmit or terminate torque output;
the disengagement mechanism includes a key sleeve, an inner key of the key sleeve is engaged with a key shaft, and an outer key of the key sleeve is engaged with a keyway in a transmitting gear; and
the key sleeve is movable on the key shaft along an axial direction; and when the outer key of the key sleeve is disengaged from the keyway in the transmitting gear, torque is not transmitted between the transmitting gear and the key sleeve.

On the basis of the above solution and as a preferred solution of the above solution, the gear set includes an input gear and an outgoing shaft; the key sleeve is provided at one end of the key shaft; the transmitting gear is fitted onto a middle of the key shaft; the transmitting gear is engaged with the input gear and the transmitting gear is rotatable around the key shaft; one side of the transmitting gear is provided with a toothed groove occluded with the outer key of the key sleeve; the outer key is embedded into the toothed groove, the key sleeve rotates synchronously with the transmitting gear, and the key sleeve drives the key shaft to rotate at the same time; the other end of the key shaft is provided with a transmission gear; the key shaft drives the transmission gear to rotate, and the transmission gear is engaged with the outgoing shaft to rotate synchronously; and the input gear, the outgoing shaft, the transmitting gear, the transmission gear and the key shaft are clamped and fixed between the box body and the box cover.

On the basis of the above solution and as a preferred solution of the above solution, the disengageable gearbox for an electric pallet truck further includes a secondary shaft; one end of the secondary shaft is provided with a secondary pin pit, the input gear is fitted onto the secondary shaft and is fixedly clamped by inserting a secondary pin column, a secondary gear protrudes from a surface of the other end of the secondary shaft, and the secondary gear is engaged with the transmitting gear.

On the basis of the above solution and as a preferred solution of the above solution, a middle of an outer surface of the key sleeve is depressed to form an annular first clamping groove; the disengageable gearbox for an electric pallet truck further includes a shifting column; the shifting column is rod-shaped, and a tail end of the shifting column passes through the box cover and is inserted into the box body; a shifting fork is fixed on the shifting column, the shifting fork includes two fork legs, an arc-shaped first notch is provided between the two fork legs, and a top of the shifting fork is provided with a shaft hole for inserting the shifting column for fixing; the two fork legs of the shifting fork clamp the first clamping groove in the key sleeve; and the shifting column drives the shifting fork to move, and the shifting fork synchronously drives the key sleeve to move on the key shaft to achieve disassembling or assembling of the key sleeve and the transmitting gear.

On the basis of the above solution and as a preferred solution of the above solution, a surface of a middle end of the shifting column is depressed to form a first pit; the shaft hole is provided with a run-through first threaded hole, and an internal hexagonal screw is screwed into the first threaded hole and inserted into the first pit for fixing; a surface of a tail end of the shifting column is provided with two turns of side-by-side annular second clamping grooves; and the box body is provided with a second threaded hole, and a steel ball jack screw is screwed into the second threaded hole and pressed against the second clamping groove to achieve limiting.

On the basis of the above solution and as a preferred solution of the above solution, a surface of a head end of the shifting column is provided with a run-through first hanging hole, and a pull ring is provided in the first hanging hole.

Compared with the existing technology, the present disclosure has the following prominent and beneficial technical effects:

1: Since the pallet truck is provided with a driving motor and a gearbox, walking through electric driving can be achieved. Since the gearbox can drive a wheel to rotate freely through the disengagement mechanism, walking by pushing or pulling manually can be achieved. Therefore, it has the effect of driving in two ways. Since the gearbox is provided with an input gear and an output gear, the input gear is engaged with an input shaft of the driving motor to provide a power source, the output gear drives the driving wheel to rotate through a transmission shaft, and walking can be achieved.

The disengagement mechanism is additionally provided between the input gear and the output gear. The disengagement mechanism achieves engagement or disengagement of the gears, so that the gears have a function of transmitting torque output or terminating torque output. The disengagement mechanism includes a key shaft, and a key sleeve and a transmitting gear which are fitted onto the key shaft, a transmission gear is fixed on the key shaft, a surface of the key sleeve is provided with an outer key, and a toothed groove matching with the outer key is provided in the transmitting gear.

After the transmitting gear and the key sleeve are assembled, the key sleeve rotates to drive the key shaft to rotate, the transmission gear rotates and the output gear rotates. Conversely, the key sleeve and the transmitting gear are disassembled from each other, electric driving cannot be achieved, but the driving wheel is not constrained by the transmitting gear, the situation that the gears are all engaged is avoided and free rotation can be achieved, so that the effect of manual driving is achieved and two driving ways using one gearbox is achieved, which achieves two purposes at the same time.

2: The disengagement mechanism may be provided with a secondary gear or a multi-stage gear to achieve different reduction ratios, so that it is more practical.

3: Since it further includes a shifting column, the shifting column is connected with a shifting fork and the shifting fork is fitted onto the key sleeve. By pushing in and pulling out the shifting column, the shifting fork can be moved on to make the key sleeve move on the key shaft.

4: Since the internal hexagonal screw passes through the shifting fork and is fixed to the shifting column, the shifting column is prevented from being pulled out from the shifting fork and the shifting fork is blocked by the box cover, thus achieving two purposes at the same time. Since the tail of the shifting column is provided with two second clamping grooves corresponding to the assembled and disassembled states respectively, and the steel ball jack screw is pressed against the second clamping groove, it helps the operator to perceive and is more user-friendly.

### BRIEF DESCRIPTION OF FIGURES

FIG. 1 is an overall schematic structural diagram after mounting according to the present disclosure.

FIG. 2 is a schematic exploded structural diagram according to the present disclosure.

FIG. 3 is an overall schematic sectional structural diagram according to the present disclosure.

FIG. 4 is an overall schematic sectional structural diagram according to the present disclosure.

FIG. 5 is a partial schematic sectional structural diagram according to the present disclosure.

FIG. 6 is a partial schematic exploded structural diagram according to the present disclosure.

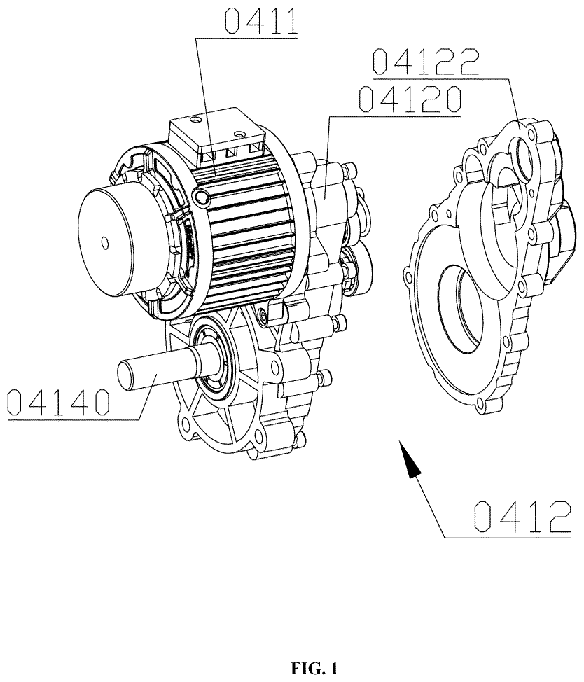

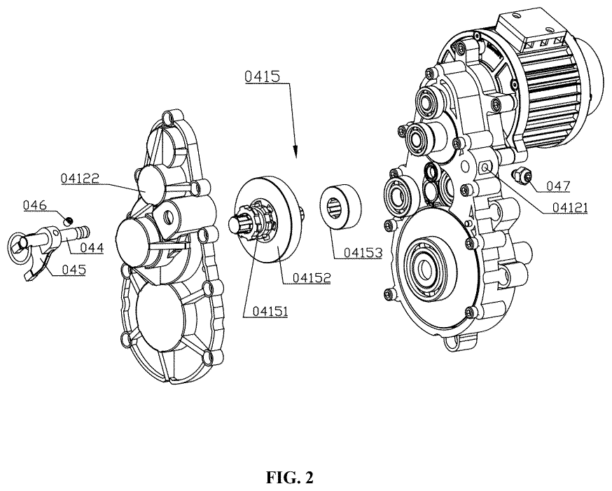

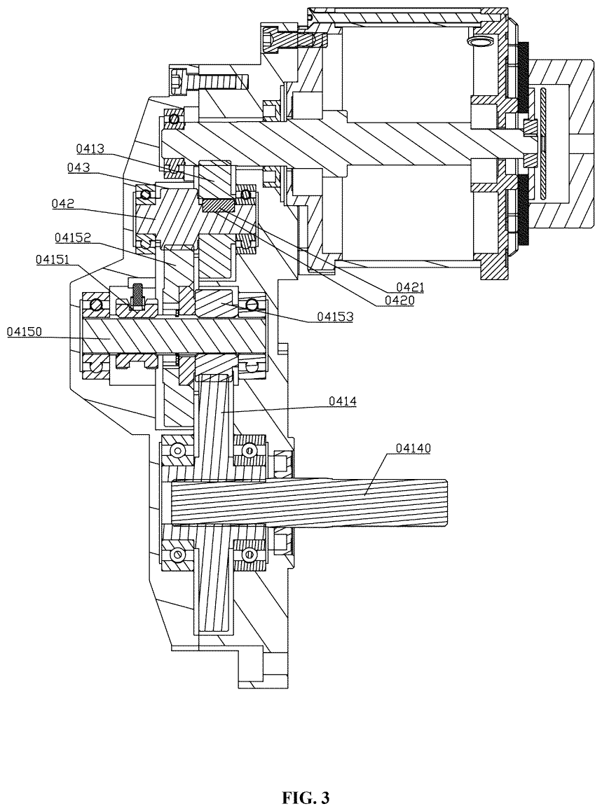

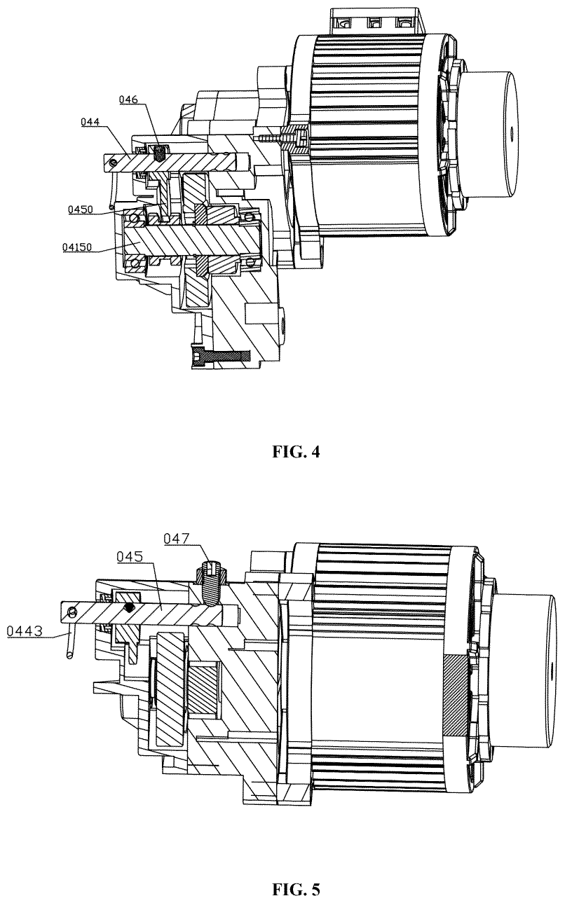

Description of reference signs: 0411—driving motor; 0412—gearbox; 04120—box body; 04121—second threaded hole; 04122—box cover; 0413—input gear; 0414—output gear; 04140—transmission shaft; 0415—disengagement mechanism; 04150—key shaft; 04151—key sleeve; 041510—first clamping groove; 041511—outer key; 04152—transmitting gear; 041520—toothed groove; 04153—transmission gear; 042—secondary shaft; 0420—secondary pin pit; 0421—secondary pin column; 043—secondary gear; 044—shifting column; 0440—first pit; 0441—second clamping groove; 0442—first hanging hole; 0443—pull ring; 045—shifting fork; 0450—fork leg; 0451—first notch; 0452—shaft hole; 0453—first threaded hole; 046—internal hexagonal screw; and 047—steel ball jack screw.

### DETAILED DESCRIPTION

The present disclosure will be further described below through specific embodiments in conjunction with the drawings.

This embodiment provides a disengageable gearbox for an electric pallet truck. The gearbox 0412 includes a box body 04120 and a box cover 04122 assembled with the box body 04120. The box body 04120 and the box cover 04122 are assembled to form a mounting chamber. The box body 04120 and the box cover 04122 are made of a metal material, and they are assembled and fixedly connected by bolts. The mounting chamber which is formed by the box body 04120 and the box cover 04122 after assembling is used for mounting gears, bearings and other parts.

A gear set is mounted in the box body to transmit torque, change speed, and change a direction of torque. A disengagement mechanism 0415 is provided in the gear set. The disengagement mechanism 0415 achieves engagement or disengagement of the gear set, so that the gear set has a function of transmitting torque output or terminating torque output.

As described above, the disengagement mechanism on the gearbox allows it to have two working states. One is that the gears are engaged to have a function of transmitting torque output, and the other is that the gears are disengaged to have a function of terminating torque output. In this way, even when the gearbox cannot work, the pallet truck can still achieve walking by pushing and pulling manually.

The disengagement mechanism includes a key sleeve 04151. The key sleeve is provided with an inner key and an outer key 041511. Several outer keys 041511 protrude from an inner side of an outer surface of the key sleeve 04151. The outer keys are block-shaped, and a cross section may be square, trapezoidal, triangular, etc.

The disengagement mechanism 0415 includes a key shaft 04150. The key shaft 04150 is cylindrical. An outer surface of the key shaft 04150 is provided with a longitudinal keyway. A shape of the keyway is designed according to the requirement. In addition to the spline way, other keyways such as flat keyway and semi-circular keyway may be used.

The outer key of the key sleeve is engaged with the keyway in a transmitting gear. The key sleeve 04151 rotates synchronously with the key shaft 04150 and can slide axially. A keyway matching with the key shaft is provided in a middle of an inside of the key sleeve 04151, which can maintain synchronous rotation with the key shaft 04150. When needed, it can also slide axially on the key shaft 04150.

When the outer key of the key sleeve is disengaged from the keyway in the transmitting gear, torque is not transmitted between the transmitting gear and the key sleeve.

As described above, the key sleeve and the transmitting gear are fitted onto the key shaft, the key sleeve is engaged with the transmitting gear, the transmitting gear rotates to drive the key sleeve to rotate, and the key shaft rotates with the key sleeve, thus achieving the torque transmission of the gear set.

The key sleeve is disengaged from the transmitting gear, the transmitting gear rotates relative to the key shaft, and the key sleeve and the key shaft do not rotate with the transmitting gear, thus terminating the torque transmission of the gear set.

Further, a casing of a driving motor 0411 is fixedly connected with the box body 04120 through bolts. An output shaft of the driving motor 0411 is inserted into the box body 04120. The output shaft of the driving motor 0411 is engaged with an input gear 0413. The driving motor 0411 drives the input gear 0413 to rotate. In another embodiment, the input gear may be teeth provided on the output shaft of the driving motor.

The key sleeve 04151 is provided at one end of the key shaft 04150. The transmitting gear 04152 is fitted onto a middle of the key shaft 04150. An outer surface of the transmitting gear 04152 is provided with teeth. The transmitting gear 04152 is engaged with the input gear 0413. The transmitting gear 04152 can rotate around the key shaft 04150. A smooth circular hole is provided in a middle of an inside of the transmitting gear 04152, which is fitted onto the key shaft 04150 without being influenced by the keyway.

One side of the transmitting gear 04152 is provided with a toothed groove 041520 matching with the outer key 041511. The outer key 041511 is embedded into and occluded with the toothed groove 041520. The key sleeve 04151 rotates synchronously with the transmitting gear 04152, and drives the key shaft 04150 to rotate at the same time. When the outer key 041511 is disengaged from toothed groove 041520, the key sleeve 04151 does not rotate, and the key shaft 04150 stops rotating.

The other end of the key shaft 04150 is provided with a transmission gear 04153. The transmission gear may be a fixed gear plate which is additionally fitted outside, or teeth provided on the surface of the key shaft.

The key shaft 04150 drives the transmission gear 04153 to rotate. The transmission gear 04153 is engaged with an outgoing shaft 04140 and rotates synchronously. Teeth are provided on the outgoing shaft for engagement. The transmission shaft is directly inserted into a driving wheel for walking.

In another embodiment, the outgoing shaft 04140 is embedded into a middle of the output gear 0414, and the outgoing shaft 04140 passes through the box body 04120 and is inserted into the driving wheel to drive rotation. The input gear 0413 and the output gear 0414 are existing conventional gears.

The transmission gear 04153 is engaged with the output gear 0414 and rotates synchronously. The keyway is provided in a middle of the transmission gear 04153, which is inserted into the keyway in the key shaft 04150 to form a connection with each other. The transmission gear 04153 rotates synchronously with the key shaft 04150.

The input gear 0413, the output gear 0414, the transmitting gear 04152, the transmission gear 04153 and the key shaft 04150 are clamped and fixed between the box body 04120 and the box cover 04122.

Preferably, bearings are respectively fitted onto ends of the driving motor 0411, ends of the key shaft 04150 and ends of the output gear 0414 to facilitate rotation.

As described above, in the specific use process, when driving the gearbox electrically, the key sleeve 04151 is assembled with the transmitting gear 04152, and the outer key 041511 is embedded in the toothed groove 041520; the output shaft of the driving motor 0411 rotates, thus driving the input gear 0413 to rotate, driving the transmitting gear 04152 to rotate, driving the key sleeve 04151 to rotate, then driving the key shaft 04150 to rotate, driving the transmission gear 04153 to rotate, driving the output gear 0414 to rotate, driving the outgoing shaft 04140 to rotate, and finally driving the driving wheel to rotate.

In a case that manual walking is required, the key sleeve 04151 is shifted away from the transmitting gear 04152 so that the two are disengaged and the torque output of the gear set is terminated. The driving wheel is pushed or pulled manually to walk, the transmission shaft rotates, the output gear 0414 rotates, the transmission gear 04153 rotates, and the key shaft 04150 and the key sleeve 04151 rotate, but the transmitting gear 04152 does not rotate and remains stationary relative to the key shaft. It can be applied to situations where the driving motor 0411 is damaged and unable to work, or the driving motor 0411 is powered off and the pallet truck is stuck on the road. By using the disengagement mechanism 0415 to release the engagement of the gears, manual pushing or pulling can be achieved, and it is safer and more practical. It solves the problems that the existing gearbox 0412 cannot achieve driving and the pallet truck cannot move.

Further, the disengageable gearbox for an electric pallet truck further includes a secondary shaft 042; one end of the secondary shaft 042 is provided with a secondary pin pit 0420, the input gear 0413 is fitted onto the secondary shaft 042 and is fixedly clamped by inserting a secondary pin column 0421, a secondary gear 043 protrudes from a surface of the other end of the secondary shaft 042, and the secondary gear 043 is engaged with the transmitting gear 04152.

As described above, the secondary gear 043 is additionally provided between the driving motor 0411 and the disengagement mechanism 0415, so as to reduce the speed and achieve the desired reduction ratio.

Preferably, in order to achieve different reduction ratio design requirements, in addition to the secondary gear, a multi-stage gear may be provided between the driving motor 0411 and the disengagement mechanism 0415, and then is engaged with the transmitting gear 04152 of the disengagement mechanism 0415.

Further, a middle of the outer surface of the key sleeve 04151 is depressed to form an annular first clamping groove 041510. The first clamping groove 041510 is used for inserting an external tool to shift the key sleeve 04151 to move. The disengageable gearbox for an electric pallet truck further includes a shifting column 044. The shifting column 044 is rod-shaped. A tail end of the shifting column 044 passes through the box cover 04122 and is inserted into the box body 04120. A head end of the shifting column 044 is left outside the box cover 04122. The box body 04120 and the box cover 04122 wrap the disengagement mechanism 0415.

A shifting fork 045 is fixed on the shifting column 044. The shifting fork 045 includes two fork legs 0450. An arc-shaped first notch 0451 is provided between the two fork legs 0450. A top of the shifting fork 045 is provided with a shaft hole 0452 for inserting the shifting column 044 for fixing.

As described above, by inserting and pulling out the shifting column 044, the shifting fork 045 is driven to move. The top of the shifting fork 045 is blocked by the box cover 04122 to prevent the shifting column 044 from being completely pulled out. The shifting column 044 is erected to move between the box body 04120 and the box cover 04122.

The two fork legs 0450 of the shifting fork 045 clamp the first clamping groove 041510 in the key sleeve 04151. The shifting column 044 drives the shifting fork 045 to move, and the shifting fork 045 synchronously drives the key sleeve 04151 to move on the key shaft 04150 to achieve disassembling or assembling of the key sleeve 04151 and the transmitting gear 04152.

As described above, in the specific use process, for the convenience and safety in use, the shifting column 044 and the shifting fork 045 are additionally provided, the shifting fork 045 clamps the key sleeve 04151, and the shifting column 044 and the shifting fork 045 are fixedly connected. By inserting and pulling out the shifting column 044, the shifting fork 045 is driven to move, and the key sleeve 04151 moves with the shifting fork 045, thus achieving assembling or disassembling of the transmitting gear 04152.

Further, a surface of a middle end of the shifting column 044 is depressed to form a first pit 0440. The shaft hole 0452 is provided with a run-through first threaded hole 0453. An internal hexagonal screw 046 is screwed into the first threaded hole 0453 and inserted into the first pit 0440 for fixing.

As described above, the hexagon socket screw 046 is screwed between the shifting fork 045 and the shifting column 044 for fixing, and connection is achieved by adopting a screw, thus facilitating the replacement and meeting the design requirement for disassembling as a whole. In addition to the internal hexagonal screw 046, other screws, such as headless screws, may also be used.

A surface of the tail end of the shifting column 044 is provided with two turns of side-by-side annular second clamping grooves 0441. The second clamping grooves 0441 are close to each other. The second clamping grooves 0441 are designed around the shifting column 044. The box body 04120 is provided with a second threaded hole 04121. A steel ball jack screw 047 is screwed into the second threaded hole 04121 and pressed against the second clamping groove 0441 to achieve limiting.

As described above, after the shifting column 044 is inserted and pulled out for many times, in order to prevent the shifting column 044 from being excessively inserted and pulled out to avoid insufficient assembling or disassembling of the key sleeve 04151 and the transmitting gear 04152, second clamping grooves 0441 are provided in the tail end of the shifting column 044, and a steel ball at the head of the steel ball jack screw 047 is pressed against the second clamping grooves 0441 to indicate that the shifting column 044 is in place. The operator can more accurately feel the impact of the steel ball jack screw 047 and hear the sound. The two second clamping grooves 0441 represent two working positions.

A surface of a head end of the shifting column 044 is provided with a run-through first hanging hole 0442. A pull ring 0443 is provided in the first hanging hole 0442.

As described above, the operator's finger hooks the pull ring 0443 to conveniently pulling the shifting column 044.

In the description of the present disclosure, it should be understood that directional and positional relationships indicated by terms such as “up”, “down”, “top”, “bottom”, “inside” and “outside” are directional or positional relationships based on the drawings, directional or positional relationships formed by commonly placing the product of the present disclosure in use, or directional or positional relationships commonly understood by those skilled in the art, which are only for the purposes of conveniently describing the present disclosure and simplifying the description, instead of indicating or implying that the apparatus or element referred to must have a specific orientation or be constructed and operated in a specific orientation, and cannot be understood as limiting the present disclosure.

In addition, the terms “first” and “second” are only for the purpose pf description and cannot be understood as indicating or implying relative importance or implying the quantity of technical features referred to. In the present disclosure, unless otherwise clearly specified and limited, the terms “mount”, “provide”, “connect”, “fix”, “screw” and other terms should be broadly understood. For example, it may be fixed connection, detachable connection, or integral connection; it may also be mechanical connection or electrical connection.

The above embodiments are only the preferred embodiments of the present disclosure, which, however, do not limit the scope of protection of the present disclosure. Therefore, any equivalent changes made according to the structure, shape, and principle of the present disclosure should be included in the scope of protection of the present disclosure.

What is claimed is:

1. A disengageable gearbox for an electric pallet truck, comprising:
a box body and a box cover assembled with the box body, wherein the box body and the box cover are assembled to form a mounting chamber;
a gear set is mounted in the box body and a disengagement mechanism is provided in the gear set;
the disengagement mechanism achieves engagement or disengagement of the gear set, so that the gear set has a function of transmitting torque output or terminating torque output;
the disengagement mechanism comprises a key sleeve, an inner key of the key sleeve is engaged with a key shaft, and an outer key of the key sleeve is engaged with a keyway in a transmitting gear; and
the key sleeve is movable on the key shaft along an axial direction; and when the outer key of the key sleeve is disengaged from the keyway in the transmitting gear, torque is not transmitted between the transmitting gear and the key sleeve.

2. The disengageable gearbox for an electric pallet truck according to claim 1, wherein
the gear set comprises an input gear and an outgoing shaft;
the key sleeve is provided at one end of the key shaft; the transmitting gear is fitted onto a middle of the key shaft; the transmitting gear is engaged with the input gear and the transmitting gear is rotatable around the key shaft; one side of the transmitting gear is provided with a toothed groove occluded with the outer key of the key sleeve; and the outer key is embedded into the toothed groove, the key sleeve rotates synchronously with the transmitting gear, and the key sleeve drives the key shaft to rotate at the same time;
the other end of the key shaft is provided with a transmission gear; the key shaft drives the transmission gear to rotate, and the transmission gear is engaged with the outgoing shaft to rotate synchronously; and
the input gear, the outgoing shaft, the transmitting gear, the transmission gear and the key shaft are clamped and fixed between the box body and the box cover.

3. The disengageable gearbox for an electric pallet truck according to claim 2, wherein the disengageable gearbox for an electric pallet truck further comprises a secondary shaft; one end of the secondary shaft is provided with a secondary pin pit, the input gear is fitted onto the secondary shaft and is fixedly clamped by inserting a secondary pin column, a secondary gear protrudes from a surface of the other end of the secondary shaft, and the secondary gear is engaged with the transmitting gear.

4. The disengageable gearbox for an electric pallet truck according to claim 1, wherein a middle of an outer surface of the key sleeve is depressed to form an annular first clamping groove;
the disengageable gearbox for an electric pallet truck further comprises a shifting column; the shifting column is rod-shaped, and a tail end of the shifting column passes through the box cover and is inserted into the box body; and a shifting fork is fixed on the shifting column, the shifting fork comprises two fork legs, an arc-shaped first notch is provided between the two fork legs, and a top of the shifting fork is provided with a shaft hole for inserting the shifting column for fixing; and
the two fork legs of the shifting fork clamp the first clamping groove in the key sleeve; the shifting column drives the shifting fork to move, and the shifting fork synchronously drives the key sleeve to move on the key shaft to achieve disassembling or assembling of the key sleeve and the transmitting gear.

5. The disengageable gearbox for an electric pallet truck according to claim 4, wherein a surface of a middle end of the shifting column is depressed to form a first pit; the shaft hole is provided with a run-through first threaded hole, and an internal hexagonal screw is screwed into the first threaded hole and inserted into the first pit for fixing; and
a surface of a tail end of the shifting column is provided with two turns of side-by-side annular second clamping grooves; the box body is provided with a second threaded hole, and a steel ball jack screw is screwed into the second threaded hole and pressed against the second clamping groove to achieve limiting.

6. The disengageable gearbox for an electric pallet truck according to claim 4, wherein a surface of a head end of the shifting column is provided with a run-through first hanging hole, and a pull ring is provided in the first hanging hole.
